(19) United States
(12) Patent Application Publication
(10) Pub. No.: US 2026/0169320 A1
(43) Pub. Date: Jun. 18, 2026

(54) STRUCTURE FOR OVERCOMING POLARITY REVERSAL IN DUAL-FERROELECTRIC-CRYSTAL-PAIRED ELECTRO-OPTIC DEVICE AND USING METHOD

(71) Applicant: Guilin Bairui Optoelectronics Technology Co., Ltd., Guilin (CN)

(72) Inventors: Xiaoling He, Guilin (CN); Changlong Zhang, Guilin (CN); Haitao Zhou, Guilin (CN); Wenyuan Wu, Guilin (CN)

(21) Appl. No.: 19/464,601

(22) Filed: Jan. 30, 2026

(30) Foreign Application Priority Data
Apr. 3, 2025 (CN) 202510418518.5

(51) Int. Cl. G02F 1/05

(52) U.S. Cl. CPC G02F 1/0508

(57) ABSTRACT

A structure for overcoming polarity reversal in a dual-ferroelectric-crystal-paired electro-optic device is provided. The structure is in a shape of a parallelogram and includes a first crystal, a second crystal, a first reflector and a second reflector, where the first crystal, the second crystal, the first reflector, and the second reflector are all provided on the same metal plate, the first crystal and the first reflector are located at the upper side of the parallelogram, and the second crystal and the second reflector are located at the lower side of the parallelogram, the first reflector reflects the laser light transmitted through the first crystal to the second reflector at the lower side of the parallelogram, and the second reflector reflects the light to the light-transmitting face of the second crystal. In the present disclosure, a voltage is applied only to the first crystal in the spontaneous polarization direction.

### CROSS REFERENCE TO RELATED APPLICATIONS

The present disclosure claims the priority to the Chinese patent application with the filing No. 202510418518.5, entitled “STRUCTURE FOR OVERCOMING POLARITY REVERSAL IN DUAL-FERROELECTRIC-CRYSTAL-PAIRED ELECTRO-OPTIC DEVICE AND USING METHOD” and filed on Apr. 3, 2025 with the Chinese Patent Office, the contents of which are incorporated herein by reference in their entirety.

### TECHNICAL FIELD

The present disclosure relates to the technical field of electro-optic crystal device fabrication, and more particularly to a structure for overcoming polarity reversal in a dual-ferroelectric-crystal-paired electro-optic device (i.e., an electro-optic device composed of paired ferroelectric crystals) and a using method.

### BACKGROUND ART

The use of electro-optic devices is common means for modulating the amplitude, phase, and intensity of laser lights. Currently, the only practical electro-optic devices are the electro-optic devices based on KDP (KH₂PO₄), LN (LiNbO₃), BBO (β-BaB₂O₄), KTP (KTiOPO₄), and RTP (RbTiOPO₄), where KDP, LN, and BBO are all uniaxial crystals, and the electro-optic modulation is often achieved by using a single crystal device; while KTP and RTP are biaxial crystals with natural birefringence, and two crystals are usually used in pairs for compensation so as to offset the phase difference caused by static birefringence. [Reference patents: CN220709491U 2024, Apr. 2. VACUUM HIGH-VOLTAGE-RESISTANT RTP ELECTRO-OPTICAL SWITCH; CN112363330B 2023, Nov. 3 BICRYSTAL ELECTRO-OPTICAL SWITCH ASSEMBLING SYSTEM, ASSEMBLING METHOD AND BICRYSTAL ELECTRO-OPTICAL SWITCH; CN111817124A 2020, Oct. 23 NOVEL DOUBLE-CRYSTAL RTP POCKELS CELL ASSEMBLY; CN104858817B 2016, Aug. 24 ELECTRO-OPTICAL Q-SWITCH BICRYSTAL PAIRING CLAMPING TOOL AND USE METHOD THEREOF (all the above patents are implemented by applying voltage simultaneously to the two paired crystals)].

The pairing method for two crystals involves connecting two crystals of totally identical size in series, rotating the second crystal by 90° about the principal axis of a light propagation direction or rotating the second crystal by 180° about the principal axis of the light propagation direction, and inserting a half-waveplate between the two crystals.

In addition to electro-optical properties, KTP and RTP crystals also have ferroelectric properties. When used as a paired electro-optic device, the voltage applied to the first crystal is oriented in the forward direction of its polar Z-axis, while the voltage applied to the second crystal is oriented in the reverse direction of its polar Z-axis (referring to FIG. 1A and FIG. 2A). Under an effect of a strong electric field, the second crystal may undergo a polarity reversal, which would cause the compensation effect to fail and render the device unable to continue operating. KDP and LN crystals also possess ferroelectric properties, and when utilizing their relatively large electro-optic coefficients, static natural birefringence is also present. Therefore, there are also applications of dual-crystal paired KDP and LN electro-optic devices, which similarly face the issue of polarity reversal in one of the crystal devices.

### SUMMARY

In view of this, the present disclosure provides a structure for overcoming polarity reversal in a dual-ferroelectric-crystal-paired electro-optic device and a using method, thereby overcoming the failure problem of the electro-optic device during application.

There are two pairing modes for dual crystals: one is waveplate-based, where two crystals are placed on the same plate electrode base, with a half-waveplate inserted between them, and the specific structure is as shown in FIG. 2B; and the other is a waveplate-less-based, where the two crystals are placed on an electrode base with a V-shaped support structure, and the specific structure is as shown in FIG. 1B. In both modes, the two crystals shall both have electrodes plated on their polar faces and be arranged in series along a straight line. In operation, the positive polar face of the first crystal and the negative polar face of the second crystal are jointly connected to the positive terminal of the power supply; and simultaneously, the other two polar faces of the two crystals are jointly connected to the negative terminal of the power supply. The V-shaped support structure, due to the absence of a half-waveplate, has become the commonly used pairing mode. However, the V-shaped support is a specially shaped structure and is often made of a titanium alloy material, which renders it difficult to machine. Particularly, the machining of multiple fixing holes on the support is even more challenging, thus causing inconvenience in use.

The present disclosure proposes a method in which no voltage is applied to the second crystal, to achieve dual-crystal pairing-based compensation solution, and hereby puts forward a pairing-based compensation structure. In the present disclosure, since the voltage is applied only to the first crystal and the electric field direction is aligned with the spontaneous polarization direction of the crystal during operation, polarization reversal does not occur in this crystal. However, to reduce the requirements for high-repetition-rate power supplies, the length of a single crystal in the present disclosure needs to be greater than the length of commonly used single crystal at present, which results in an increase in device size after the two crystals are arranged in series and exceeds the length limit of the original laser device, and thus the present disclosure proposes a structure in which the two crystals are placed and arranged in parallel.

To achieve the above purposes, the present disclosure adopts the following technical solutions.

A structure for overcoming polarity reversal in a dual-ferroelectric-crystal-paired electro-optic device, where the structure is in a shape of a parallelogram and includes a first crystal, a second crystal, a first reflector and a second reflector,
where the first crystal, the second crystal, the first reflector, and the second reflector are all provided on the same metal plate, the first crystal and the first reflector are located at the upper side of the parallelogram, and the second crystal and the second reflector located at the lower side of the parallelogram, and
the first reflector is configured to reflect the laser light transmitted through the first crystal to the second reflector at the lower side of the parallelogram, and the second reflector is configured to reflect the light to the light-transmitting face of the second crystal.

The two reflectors need to be precisely adjusted so that the laser light reflected by the second reflector can be incident perpendicularly onto the light-transmitting face of the second crystal.

Preferably, the first crystal and the second crystal are consistent in size in the direction in which the electro-optic effect is utilized.

Preferably, the first crystal and the second crystal are placed in parallel in the light transmission direction.

Preferably, the positive polar face of the first crystal is placed on the metal plate, and the non-polar face of the second crystal is placed on the metal plate.

Preferably, the first crystal is plated with metal electrodes on the positive and negative polar faces thereof.

Preferably, the first crystal and the second crystal are electro-optic crystals with ferroelectric properties.

Another purpose of the present disclosure is to provide a using method of the structure for overcoming polarity reversal in a dual-ferroelectric-crystal-paired electro-optic device, including:
(1) fixing the negative polar face of the first crystal to a metal block electrode with the same size as the negative polar face by using a conductive adhesive, and leading out a wire from the metal block;
(2) fixing the positive polar face of the first crystal onto the metal plate by using the conductive adhesive, and leading out a wire from the edge of the metal plate;
(3) fixing the first reflector onto the metal plate behind the first crystal by using an epoxy resin adhesive;
(4) fixing the non-polar face of the second crystal to the metal plate below the first reflector by using the epoxy resin adhesive;
(5) fixing the second reflector onto the metal plate in front of the second crystal by using the epoxy resin adhesive;
(6) synchronously and precisely adjusting the first crystal and the second crystal, and the first reflector and the second reflector, so that only one light spot is formed after light passes through the second KTP crystal; and
(7) placing the assembled device into a laser cavity, connecting the negative polar face of the first crystal to the positive terminal of the power supply, connecting the positive polar face of the first crystal to the negative terminal of the power supply, and then applying a ½ wave voltage or a ¼ wave voltage to perform an electro-optic modulation on the laser light.

Although no voltage is applied to the second crystal, it still exhibits natural birefringence, and thus can compensate for the natural birefringence of the first crystal.

As can be seen from the above technical solutions, compared with the prior art, the present disclosure has the following beneficial effects.

In the present disclosure, a voltage is applied only to the first crystal in the spontaneous polarization direction, featuring a simple voltage connection approach and completely overcoming the problem of polarity reversal of the second crystal and preventing the device from failure problem caused by polarity reversal. Meanwhile, the second crystal does not require electrode plating, and the second crystal is fixed with the epoxy resin adhesive, which may be cured at a room temperature, reducing the stress in the device, improving overall device performance and increasing the extinction ratio. All components of the present disclosure are placed on a metal plate, and the metal plate is easier to process and fix than a V-shaped support. The structure of the present disclosure uses a parallel approach; and compared to the prior art, the device has almost no difference in length, thus exerting little impact on the size of the laser device.

### BRIEF DESCRIPTION OF DRAWINGS

In order to more clearly illustrate the technical solutions in the embodiments of the present disclosure or in the prior art, the drawings required for use in the description of embodiments or the prior art will be briefly introduced below. Obviously, the drawings described below are only embodiments of the present disclosure. For a person ordinarily skilled in the art, other drawings may be obtained based on the provided drawings without paying creative work.

FIG. 1A is a view showing the principle of dual crystal pairing on a V-shaped support; and FIG. 1B is a view showing the structure for dual crystal pairing on a V-shaped support.

FIG. 2A is a view showing the principle of waveplate-based dual crystal pairing; and FIG. 2B is a view showing the structure for waveplate-based dual crystal pairing.

FIG. 3A is a view showing the principle of dual crystal pairing in which the voltage is applied to a single crystal; and FIG. 3B is a view showing the structure for dual crystal pairing in which the voltage is applied to a single crystal.

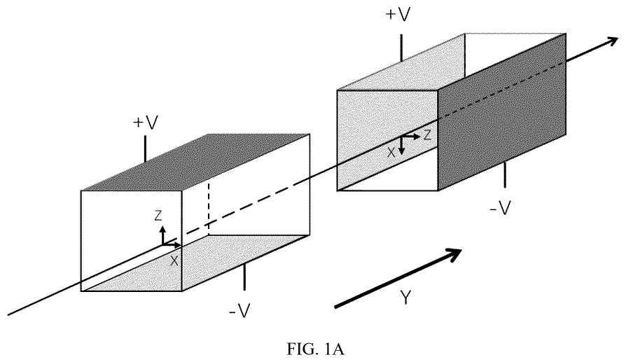

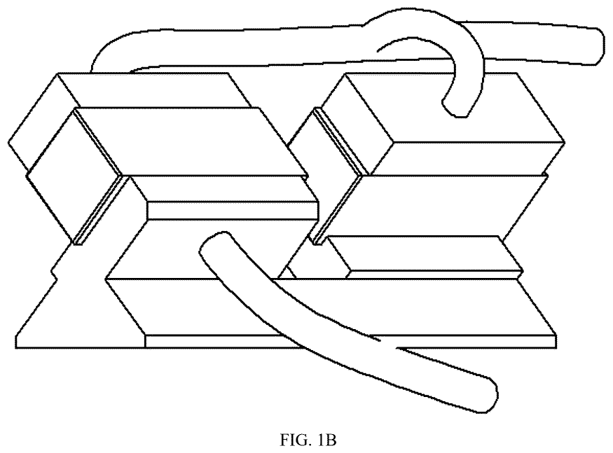

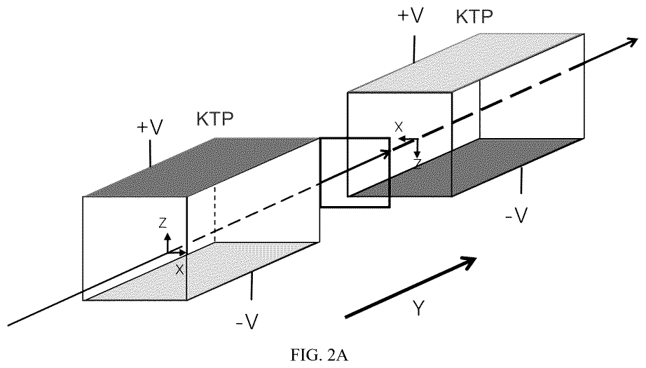

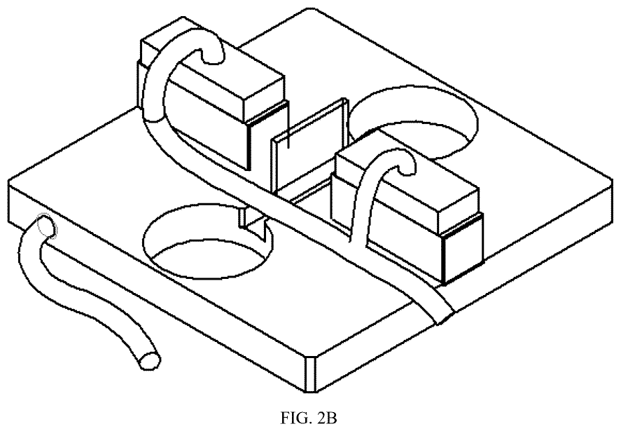

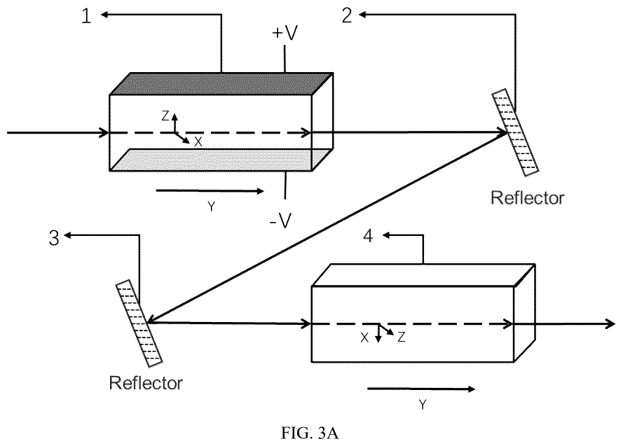

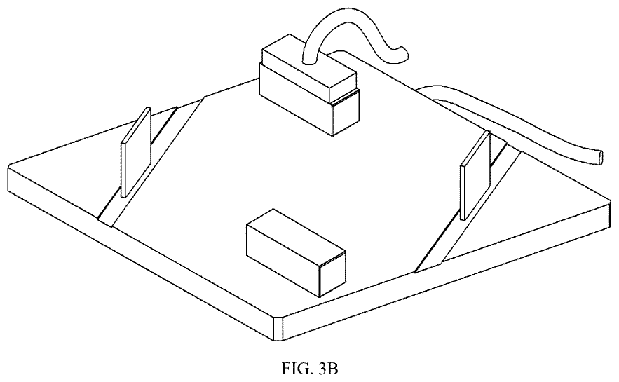

In FIGS. 3A, 1 indicates the first ferroelectric crystal, 2 indicates the first reflector, 3 indicates the second ferroelectric crystal, and 4 indicates the second reflector.

### DETAILED DESCRIPTION OF EMBODIMENTS

The technical solutions in the embodiments of the present disclosure will be clearly and completely described below in conjunction with the drawings in the embodiments of the present disclosure. Obviously, the described examples are only some of the embodiments of the present disclosure, not all of the embodiments. Based on the embodiments of the present disclosure, all other embodiments obtained by a person ordinarily skilled in the art without creative work fall within the scope of protection of the present disclosure.

### Example 1

FIG. 3A is a view showing the principle of dual crystal pairing in which the voltage is applied to a single crystal and FIG. 3B is a view showing the structure for dual crystal pairing in which the voltage is applied to a single crystal. As shown in the figure, the first crystal of the present disclosure is 1 as shown in FIG. 3A, the first reflector is 2 as shown in FIG. 3A, the second crystal is 3 as shown in FIG. 3A, and the second reflector is 4 as shown in FIG. 3A.

Exemplarily, the paired ferroelectric crystals are KTP crystals, and the sizes of the two crystals are both 4 mm×4 mm×20 mm.

Exemplarily, a quasi-static testing method is used to determine the positive and negative polar faces of the first KTP crystal. When the piezoelectric coefficient d₃₃>0, the crystal face in contact with the electrode on the piezoelectric coefficient tester is the negative polar face; and when the piezoelectric coefficient d₃₃<0, the crystal face in contact with the electrode on the piezoelectric coefficient tester is the positive polar face.

Exemplarily, electrodes are plated on the two polar faces of the first KTP crystal.

Exemplarily, a quasi-static testing method is used to determine the non-polar face of the second KTP crystal. When the piezoelectric coefficient d33≠0, the crystal face in the testing direction of the piezoelectric coefficient tester is a polar face; and when the piezoelectric coefficient d33=0, the crystal face in the testing direction of the piezoelectric coefficient tester is a non-polar face.

Exemplarily, the positive polar face of the first KTP crystal is fixed onto the base metal plate by using a conductive silver paste, and a metal block of the same material as the metal plate is adhered to the negative polar face, and has a size of 4 mm×20 mm×1.5 mm.

Exemplarily, wires are led out from the metal base and the metal block electrode of the first KTP crystal, respectively.

Exemplarily, the non-polar face of the second KTP crystal is fixed onto the base metal plate by an epoxy resin adhesive.

Exemplarily, the second KTP crystal is placed below the first KTP crystal and placed completely parallel thereto.

Exemplarily, the first reflector is placed behind the first KTP crystal, and the second reflector is placed in front of the second KTP crystal.

Exemplarily, the two KTP crystals and two reflectors are precisely adjusted so that only one light spot is formed after light passes through the second KTP crystal.

When in use, the paired KTP electro-optic device is placed inside the laser cavity; the positive terminal of the power supply is connected to the negative polar face of the first KTP crystal, and the negative terminal of the power supply is connected to the positive polar face of the first KTP crystal; and a ½ wave voltage or a ¼ wave voltage is then applied to perform electro-optic modulation on the laser light.

The embodiments according to the present disclosure can solve the problem of occurrence of the polarity reversal of the KTP crystal when the KTP electro-optic device is in use, enable almost unchanged device length, and effectively prolong the service life of the KTP electro-optic device.

In this specification, the embodiments are described in a progressive manner, and each embodiment focuses on the differences from other embodiments. The same or similar parts between the embodiments may be referred to each other. For the device disclosed in the embodiments, since it corresponds to the method disclosed in the embodiments, the description is relatively simple, and the relevant parts may be referred to the method parts.

The above description of the disclosed embodiments enables one skilled in the art to implement or use the present disclosure. Various modifications to these embodiments will be apparent to one skilled in the art, and the general principles defined herein may be implemented in other embodiments without departing from the spirit or scope of the present disclosure. Therefore, the present disclosure will not be limited to the embodiments shown herein, but rather will conform to the widest scope consistent with the principles and novel features disclosed herein.

1. A structure for overcoming polarity reversal in a dual-ferroelectric-crystal-paired electro-optic device, wherein the structure is in a shape of a parallelogram and comprises a first crystal, a second crystal, a first reflector and a second reflector;
wherein the first crystal, the second crystal, the first reflector, and the second reflector are all provided on a same metal plate, the first crystal and the first reflector are located at an upper side of the parallelogram, and the second crystal and the second reflector are located at a lower side of the parallelogram;
the first reflector is configured to reflect a laser light transmitted through the first crystal to the second reflector at the lower side of the parallelogram, and the second reflector is configured to reflect the light to a light-transmitting face of the second crystal; and
the first crystal and the second crystal are electro-optic crystals with ferroelectric properties, and metal electrodes are plated only on positive and negative polar faces of the first crystal, to which a voltage is applied.

2. The structure for overcoming polarity reversal in a dual-ferroelectric-crystal-paired electro-optic device according to claim 1, wherein the first crystal and the second crystal are consistent in size in a direction in which an electro-optic effect is utilized.

3. The structure for overcoming polarity reversal in a dual-ferroelectric-crystal-paired electro-optic device according to claim 1, wherein the first crystal and the second crystal are placed in parallel in a light transmission direction.

4. The structure for overcoming polarity reversal in a dual-ferroelectric-crystal-paired electro-optic device according to claim 1, wherein the positive polar face of the first crystal is placed on the metal plate, and a non-polar face of the second crystal is placed on the metal plate.

5. A using method of the structure for overcoming polarity reversal in a dual-ferroelectric-crystal-paired electro-optic device according to claim 1, comprising:
(1) fixing the negative polar face of the first crystal to a metal block electrode with a same size as the negative polar face by using a conductive adhesive, and leading out a wire from the metal block;
(2) fixing the positive polar face of the first crystal on the metal plate by using the conductive adhesive, and leading out a wire from an edge of the metal plate;
(3) fixing the first reflector on the metal plate behind the first crystal by using an epoxy resin adhesive;
(4) fixing a non-polar face of the second crystal to the metal plate below the first reflector by using the epoxy resin adhesive;
(5) fixing the second reflector on the metal plate in front of the second crystal by using the epoxy resin adhesive;
(6) synchronously and precisely adjusting the first crystal and the second crystal, and the first reflector and the second reflector, so that only one light spot is formed after the light passes through the second crystal; and
(7) placing an assembled device into a laser cavity, connecting the negative polar face of the first crystal to a positive terminal of a power supply, connecting the positive polar face of the first crystal to a negative terminal of the power supply, and then applying a ½ wave voltage or a ¼ wave voltage to perform electro-optic modulation on the laser light.

6. The using method according to claim 5, wherein the first crystal and the second crystal are consistent in size in a direction in which an electro-optic effect is utilized.

7. The using method according to claim 5, wherein the first crystal and the second crystal are placed in parallel in a light transmission direction.

8. The using method according to claim 5, wherein the positive polar face of the first crystal is placed on the metal plate, and a non-polar face of the second crystal is placed on the metal plate.
